(19) United States
(12) Patent Application Publication
(10) Pub. No.: US 2011/0291472 A1
(43) Pub. Date: Dec. 1, 2011

(54) SUSPENSION UNIT

(75) Inventors: Tim Holman, Nailsea (GB); Robert D'Aubyn, Bath (GB)

(73) Assignee: HORSTMAN DEFENCE SYSTEMS LIMITED, Bath (GB)

(21) Appl. No.: 13/114,110

(22) Filed: May 24, 2011

(30) Foreign Application Priority Data
May 25, 2010 (GB) 1008705.4

(51) Int. Cl. B62D 55/15; F16F 13/00; B60G 15/06

(52) U.S. Cl. 305/133; 267/217

(57) ABSTRACT

There is disclosed a suspension unit comprising a suspension hub having a connecting element which is arranged to be secured to a vehicle chassis and a suspension arm which is mounted on the suspension hub for pivoting movement about an axis of the suspension hub. A resilient arrangement is accommodated within the suspension arm and includes a displaceable element which is connected by a connecting rod to a crank pin supported by the suspension hub at a position spaced from the hub axis. A rotational damper acts between the suspension hub and the suspension arm and comprises a first damping part and a second damping part that are rotatable with respect to one another and which define a damping chamber therebetween which is arranged to contain a damping fluid. A fluid expansion chamber is provided which is arranged to contain excess damping fluid and which is in fluid communication with the damping chamber through a fluid passageway. In use, pivoting of the suspension arm about the suspension hub causes displacement of the displaceable element and relative rotation between the first and second damping parts, thereby generating a rotational damping force.

This invention relates to a suspension unit, and is particularly, although not exclusively, concerned with a suspension unit for use on a tracked vehicle.

A tracked vehicle has a track extending around a series of track guide wheels. At least some of the guide wheels support the weight of the vehicle hull on the section of the track which is in contact with the ground. In this specification, the expression “hull” is used to refer to the main body of the vehicle. The hull serves the same purpose as the chassis of a conventional vehicle, whether or not the chassis is constituted wholly or partially by the bodywork of the vehicle. Consequently, in the context of the present invention, the word “hull” is considered to be equivalent to a vehicle chassis.

The track guide wheels which support the weight of the vehicle on the ground need to be connected to the vehicle hull by a suspension arrangement which enables the track guide wheel to move upwardly and downwardly relatively to the hull.

A suspension unit is known in which the suspension unit comprises an arm which is pivotable relatively to the hull about a pivot axis. A wheel-supporting shaft is carried by the suspension arm at a position away from the pivot axis, for supporting a track guide wheel. A resilient damping arrangement is accommodated within the arm for providing damped resilient resistance to deflection of the arm away from a static position in a direction corresponding to movement of the hull towards the ground.

The resilient damping arrangement typically comprises a gas spring and a linear fluid damper. The linear fluid damper is located within the suspension arm between the vehicle hull and the wheel supporting axis. However, the amount of space available for the damper is limited and therefore the amount of damping that can be achieved is also limited. A further disadvantage of this arrangement is that the thermal energy generated by the damper can only be dissipated from the surface of the suspension arm. However, any temperature increase in the region of the suspension arm will cause the temperature of the gas within the gas spring to increase. This will change the performance of the suspension unit which is undesirable.

It is therefore desirable to provide a suspension unit which has improved damping properties.

According to a first aspect of the invention there is provided a suspension unit comprising: a suspension hub having a connecting element which is arranged to be secured to a vehicle chassis; a suspension arm which is mounted on the suspension hub for pivoting movement about an axis of the suspension hub; a resilient arrangement accommodated within the suspension arm and including a displaceable element which is connected by a connecting rod to a crank pin supported by the suspension hub at a position spaced from the hub axis; and a rotational damper acting between the suspension hub and the suspension arm and comprising a first damping part and a second damping part that are rotatable with respect to one another; wherein in use pivoting of the suspension arm about the suspension hub causes displacement of the displaceable element and relative rotation between the first and second damping parts, thereby generating a rotational damping force. The rotational damper may be a hydraulic damper, for example. The rotational damper may be provided in the vicinity of the suspension hub. The suspension arm may have a suspension arm opening within which the suspension hub is disposed such that the suspension arm can pivot about the suspension hub. At least a portion of the rotational damper may be disposed within the suspension arm opening which may be a cylindrical opening. The first and second damping parts may be coaxial with one another and may be coaxial with the axis of rotation of the suspension arm about the hub.

The first and second damping parts may define a damping chamber therebetween which is arranged to contain a damping fluid. The first and/or second damping part may comprise a damping projection that projects into the damping chamber.

The damping chamber may be divided into at least one jounce variable volume and into at least one rebound variable volume by the at least one damping projection, wherein in use pivoting of the suspension arm about the suspension hub in the jounce direction causes the volume of the at least one jounce variable volume to decrease and the volume of the at least one rebound variable volume to increase, and pivoting of the suspension arm about the suspension hub in the rebound direction causes the volume of the at least one rebound variable volume to decrease and the volume of the at least one jounce variable volume to increase. When the suspension arm moves in the jounce direction, the or each jounce variable volume decreases and therefore the pressure of the damping fluid within the jounce variable volume(s) increases. This produces a rotational damping force. Similarly, when the suspension arm moves in the rebound direction, the or each rebound variable volume decreases and therefore the pressure of the damping fluid within the rebound variable volume(s) increases. This produces a rotational damping force.

The first damping part may comprise a casing, such as an annular casing, and the second part may comprise a hub that is disposed within the casing. The first damping part may comprise at least one inwardly extending damping projection that extends from the casing towards the hub, and the second damping part may comprise at least one outwardly extending damping projection that extends from the hub towards the casing. The or each inwardly extending damping projection may substantially abut (or may be in contact with) the hub and/or the or each outwardly extending damping projection may substantially abut (or may be in contact with) the casing.

The first damping part may comprise at least two inwardly extending damping projections that extend from the casing towards the hub, and the second damping part may comprise at least two outwardly extending damping projections that extend from the hub towards the casing. Jounce and rebound variable volume may be defined between adjacent inwardly and outwardly extending damping projections. The or each jounce variable volume may decrease in volume when the suspension arm is moved in the jounce direction and the or each rebound variable volume may increase when the suspension arm is moved in the jounce direction. The or each rebound variable volume may decrease in volume when the suspension arm is moved in the rebound direction and the or each jounce variable volume may increase when the suspension arm is moved in the rebound direction. There may be at least two jounce variable volumes and/or at least two rebound variable volumes.

A fluid damping passageway may be provided for fluid communication between adjacent jounce and rebound variable volumes. The fluid damping passageway may be provided in the or each damping projection, such as in the or each outwardly extending or in the or each inwardly extending damping projection. The fluid damping passageway may comprise at least one aperture provided in the or each damping projection with a flow restrictor disposed within the at least one aperture.

A fluid equalizing passageway may be provided for fluid communication between at least two jounce variable volumes and/or a fluid equalizing passageway may be provided for fluid communication between at least two rebound variable volumes.

The first damping part and the second damping part may be rotatable with respect to one another about the hub axis.

The first part may be coupled to the suspension hub and the second part may be coupled to the suspension arm.

If the first and second damping parts define a damping chamber therebetween, the suspension unit may further comprise a fluid expansion chamber arranged to contain excess damping fluid which is in fluid communication with the damping chamber through a fluid passageway. A replenishing valve may be disposed in the fluid passageway such that damping fluid can be supplied from the fluid expansion chamber to the damping chamber and from the damping chamber to the expansion chamber. This ensures that the damping chamber is full of damping fluid, and allows excess damping fluid to exit the damping chamber. The suspension arm may comprise a wall, such as an annular wall, defining a suspension arm opening within which the suspension hub is disposed and wherein the fluid expansion chamber is disposed within the wall.

At least one bearing element may be disposed between the wall of the suspension arm and the suspension hub. It may be possible to supply damping fluid from the fluid expansion chamber to the at least one bearing element so as to lubricate the bearing element. At least one bearing element may be disposed between the crank pin and the suspension hub. It may be possible to supply damping fluid from the fluid expansion chamber to the at least one bearing element so as to lubricate the bearing element.

The suspension arm may comprise a wall, such as an annular wall, defining a suspension arm opening within which the suspension hub is disposed. The suspension hub may comprise a central opening and the first or second damping parts may comprise a shaft portion that extends through the central opening in the suspension hub. The first or second damping part may be coupled to the suspension arm by a torque transfer cover that is coupled to the first or second damping part and the suspension arm. The torque transfer cover may cover the suspension arm opening. The torque transfer cover may be coupled to the first or second damping part by corresponding male and female spline portions.

The first and second damping parts may be provided with corresponding jounce and/or rebound stops such that in use pivoting of the suspension arm about the suspension hub is limited in the jounce and/or rebound direction by the stops. The corresponding jounce and/or corresponding rebound stops may be provided by an inwardly and an outwardly extending damping projection extending from a casing and a hub respectively. The pivoting of the suspension arm about the suspension hub may be limited in the jounce and/or rebound direction by the abutment of corresponding jounce and/or corresponding rebound abutment stops respectively. Pivoting of the suspension arm about the suspension hub in the jounce and/or rebound direction may be limited by a volume of damping fluid trapped between corresponding inwardly and outwardly extending damping projections.

The invention also concerns a vehicle having a suspension unit in accordance with any statement herein. The vehicle may be a tracked vehicle, the suspension unit may support a track guide wheel of the vehicle.

The invention may comprise any combination of the features and/or limitations referred to herein, except combinations of such features as are mutually exclusive.

Embodiments of the present invention will now be described, by way of example only, with reference to the accompanying drawings, in which:

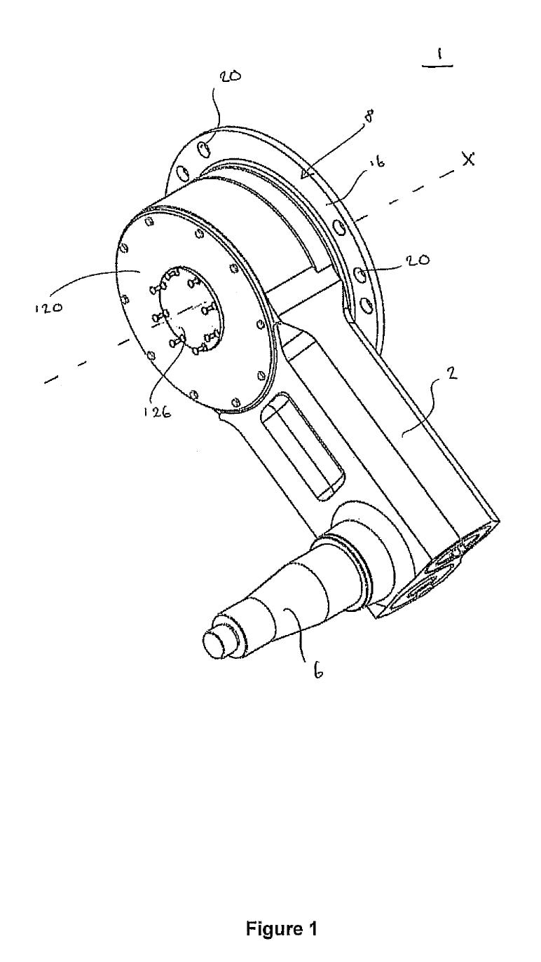

FIG. 1 schematically shows a perspective view of a suspension unit;

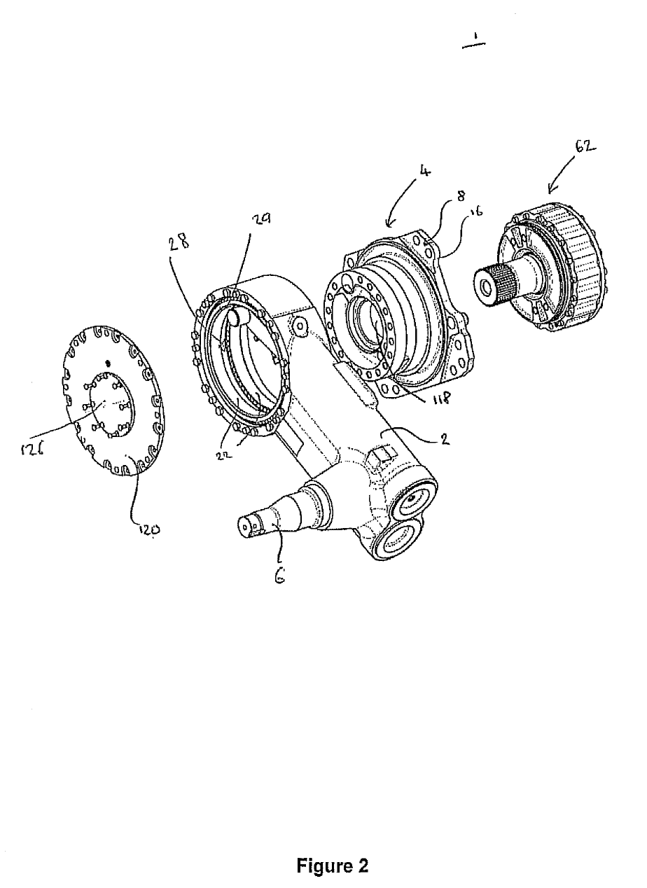

FIG. 2 schematically shows an exploded view of the suspension unit of FIG. 1;

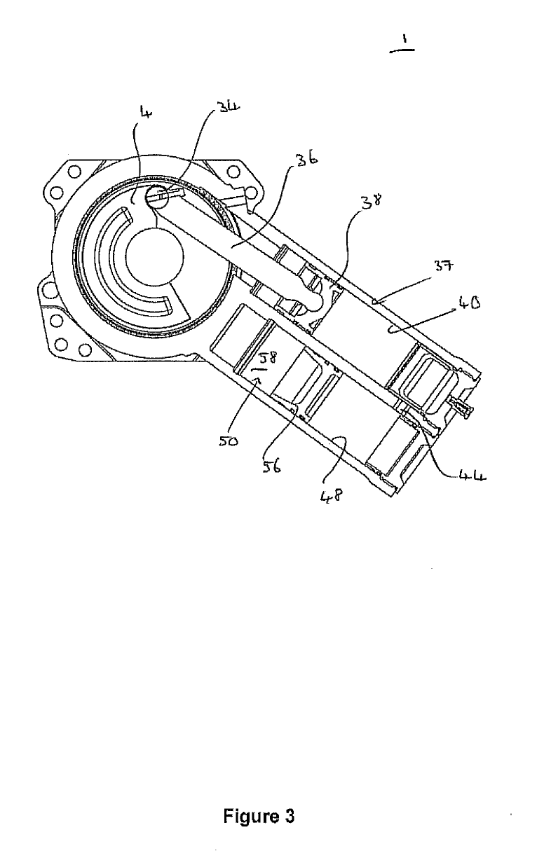

FIG. 3 schematically shows a section view of the suspension unit of FIG. 1 in a static position;

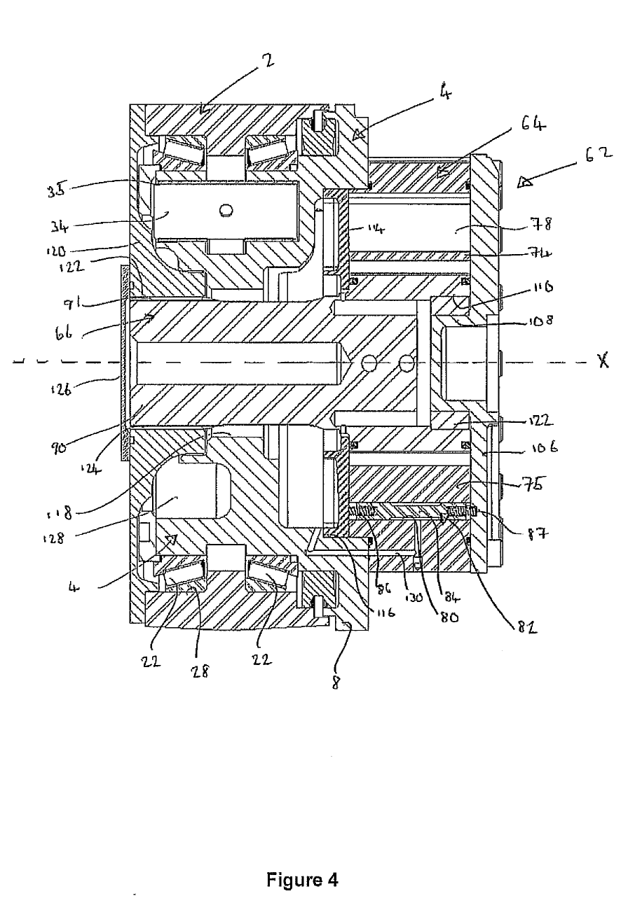

FIG. 4 schematically shows a cross-sectional view through the suspension arm, suspension hub and rotational damper;

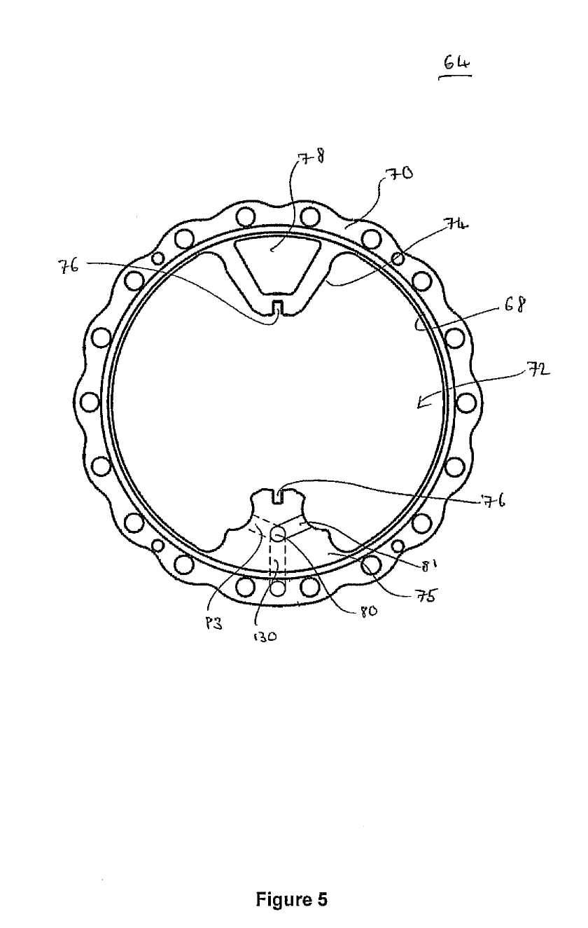

FIG. 5 schematically shows the first damping part of the rotational damper of FIG. 4;

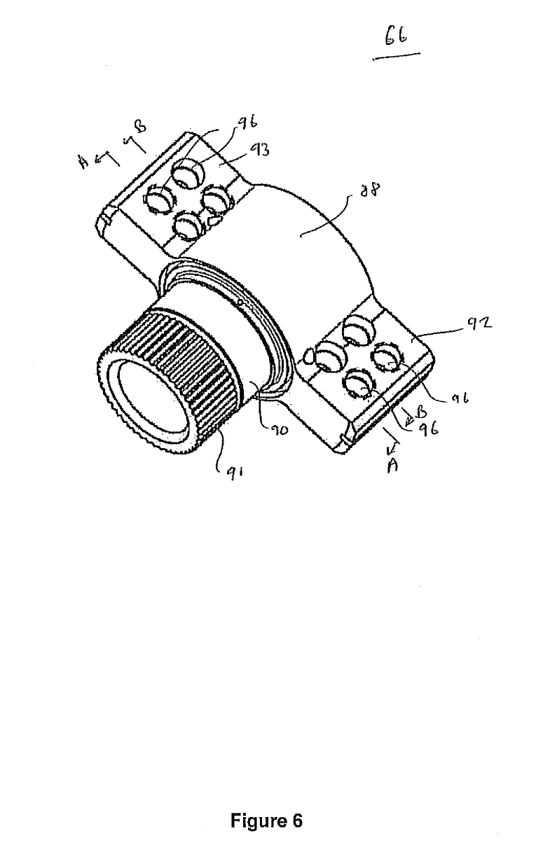

FIG. 6 schematically shows the second damping part of the rotational damper of FIG. 4;

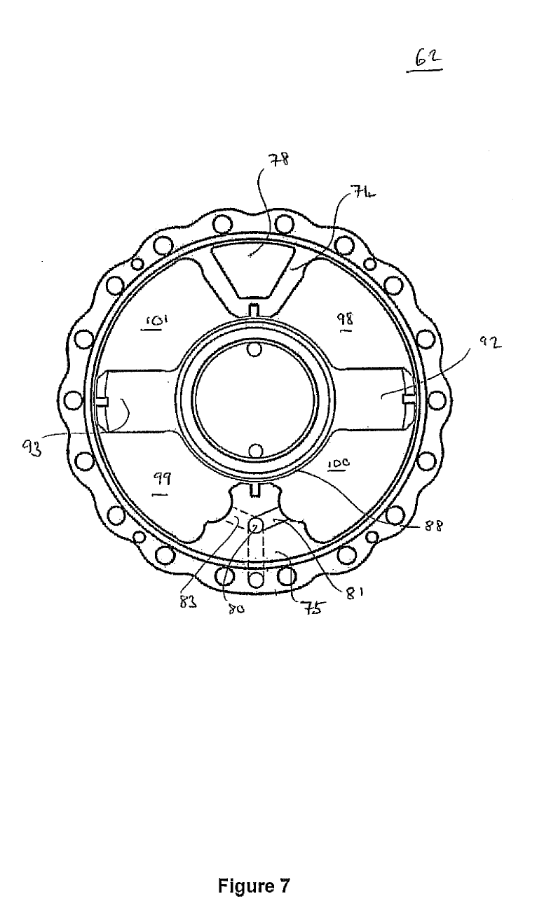

FIG. 7 schematically shows the rotational damper in a static position;

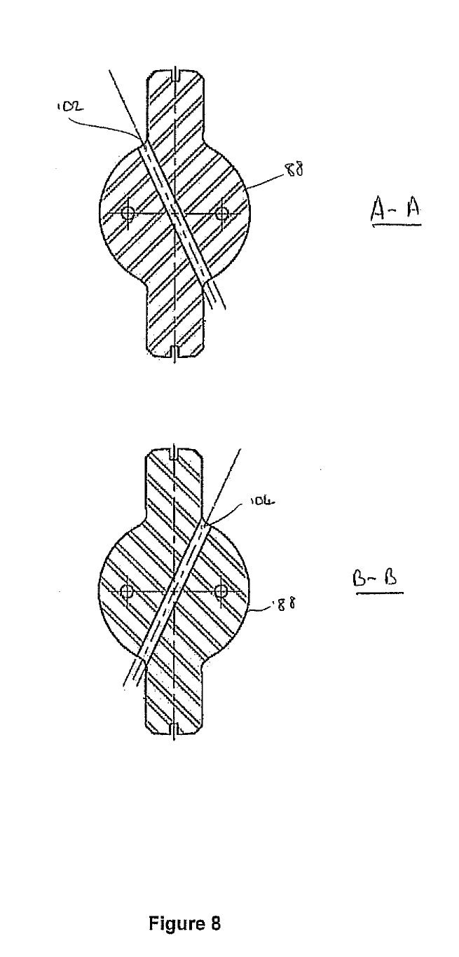

FIG. 8 schematically shows the cross-sections A-A and B-B of FIG. 6;

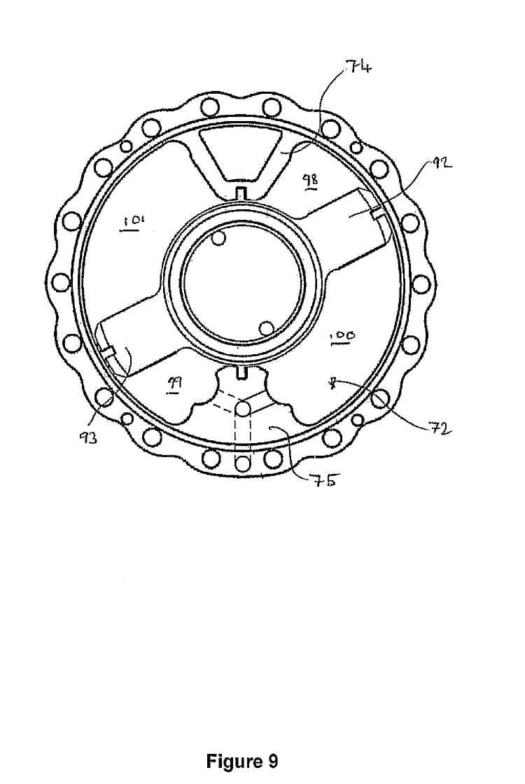

FIG. 9 schematically shows the rotational damper in a jounce position;

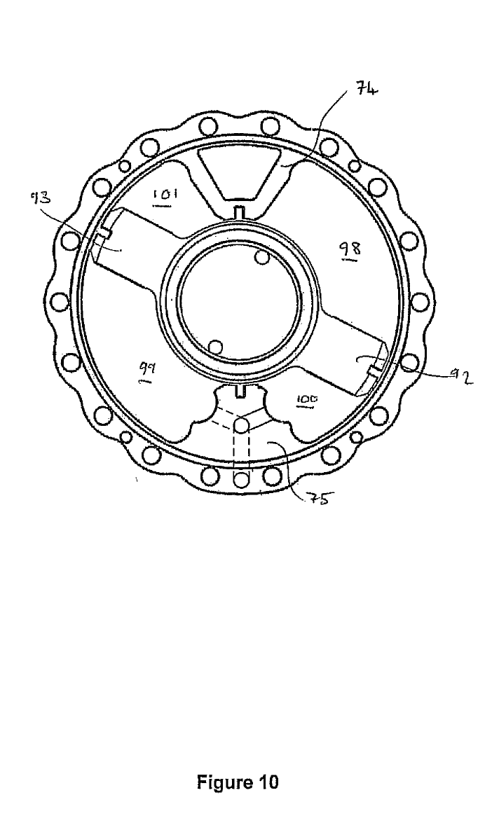

FIG. 10 schematically shows the rotational damper in a rebound position;

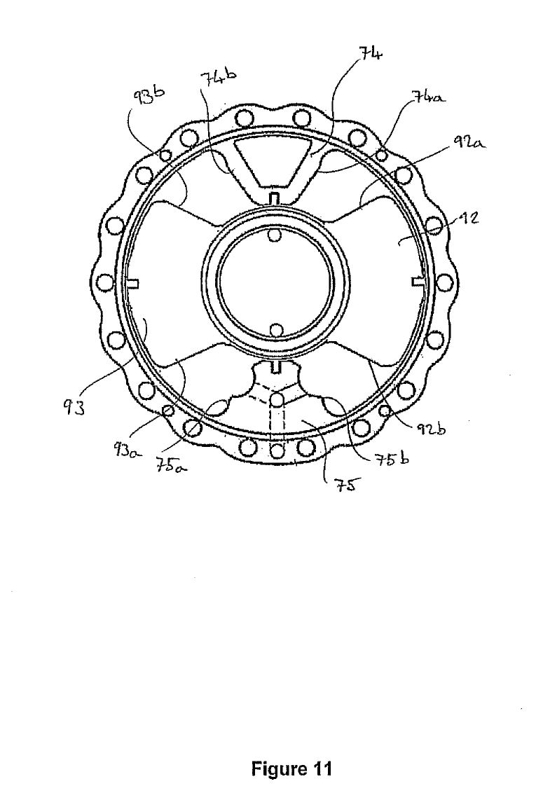

FIG. 11 schematically shows a further embodiment of a rotational damper having jounce and rebound stops;

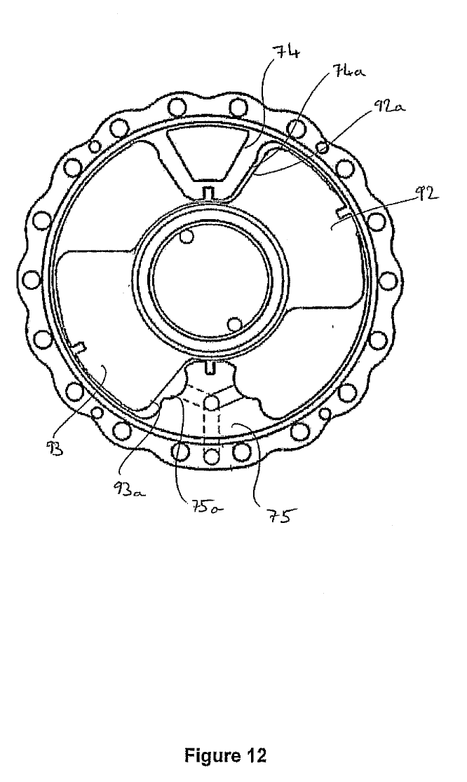

FIG. 12 schematically shows the rotational damper of FIG. 11 in a jounce position; and

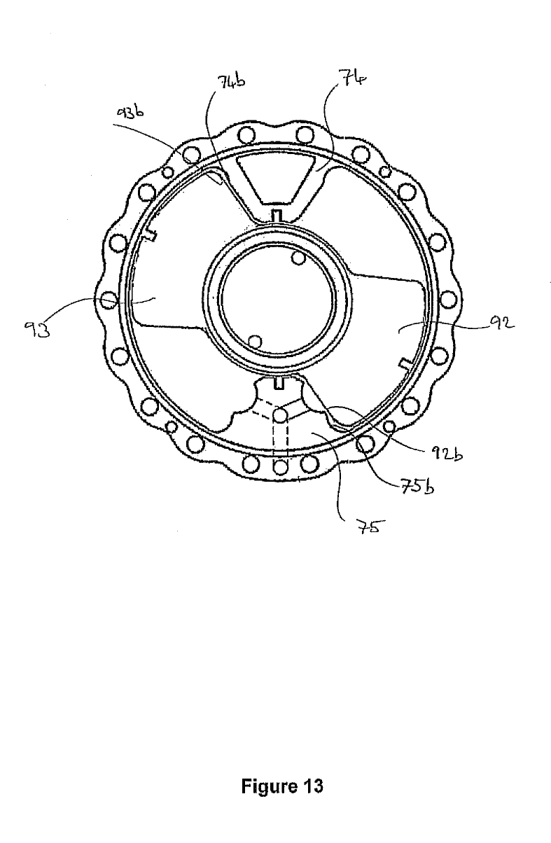

FIG. 13 schematically shows the rotational damper of FIG. 11 in a rebound position.

As shown in FIGS. 1-4, the suspension unit 1 comprises a suspension arm 2 having a cylindrical opening 28 defined by an annular wall 29, within which a suspension hub 4 is disposed. Two roller bearing elements 22 that are axially spaced from one another are disposed between the suspension hub 4 and the annular wall 29 of the suspension arm 2. The suspension hub 4 is provided with a connector element 8 having a flange 16 and the suspension arm 2 is rotatable at one end about the central axis of the suspension hub 4. The other end of the suspension arm 2 is provided with a wheel-supporting shaft 6. The suspension unit 1 also comprises a rotational damper 62 that acts between the suspension hub 4 and the suspension arm 2 about the central axis X of the suspension hub 4 and generates a rotational damping force when the suspension arm 2 is pivoted about the suspension hub 4. The rotational damper 62 comprises a first damping part 64 that is attached to the suspension hub 4 and a second damping part 66 having a shaft portion 90 that extends through a central opening 118 in the suspension hub 4 and is rotationally coupled to the suspension arm 2 by a torque transfer plate 120.

When the suspension unit is mounted on a vehicle, the connector element 8 is secured to the vehicle hull or chassis (not shown) by means of bolts which pass through countersunk holes 20 in the flange 16 into screw threaded holes in the vehicle hull.

The suspension unit 1 comprising the suspension arm 2, the suspension hub 4, the rotational damper 62 and all other internal components, is pre-assembled and supplied as a unit.

The general construction of the suspension unit 1 will now be described.

The suspension arm 2 accommodates a resilient arrangement 37 which is shown in FIG. 3. The resilient arrangement 37 comprises a chamber having a primary volume, within which a piston 38 is slidably displaceable, and a gas spring 50. The piston 38 is attached to one end of a connecting rod 36 and the other end of the connecting rod 36 is connected to a crank pin 34 which is located within an eccentrically located opening in the suspension hub 4. A bearing element 35 is disposed between the crank pin 34 and the wall of the opening in the suspension hub 4.

The chamber is defined by a first cylinder 40, within which the piston 38 is slidably disposed, and a second cylinder 48 which is substantially parallel to the first cylinder 40. The first and second cylinders 40, 48 are in fluid communication with one another through a fluid passageway 44. A gas spring 50 is provided in one end of the second cylinder 48 and comprises a variable volume chamber portion 58 and a second piston 56.

For operation, a primary fluid in the form of oil or other hydraulic fluid fills the volume of the first cylinder 40 to the right of the first piston 38 as seen in FIG. 3, the passageway 44, and the volume to the right of the second piston 56. The volume filled by the oil is collectively referred to as the primary volume. Gas, such as nitrogen, under pressure is present in the variable volume chamber portion 58.

When fitted to a vehicle, the weight of the vehicle will tend to rotate the suspension arm 2 in the counter-clockwise direction about the suspension hub 4. Since the crank pin 34 is eccentrically mounted on the suspension hub 4, this rotation will tend to drive the piston 38 to the right (as seen in FIG. 3).

In the static condition shown in FIG. 3, the piston 38 is situated approximately midway along the cylinder 40. The pressure of the gas in the volume 58 is sufficient to support the static weight of the vehicle. Consequently, the height of the vehicle hull above the ground is determined by the pressure of the gas in the volume 58.

Should the vehicle, when travelling, encounter an obstacle above the general level of the surface over which the vehicle is travelling, the track guide wheel mounted on the shaft 6 will rise relatively to the vehicle (ie relatively to the suspension hub 4). The suspension arm 2 will therefore rotate about the central axis X of the suspension hub 4 in the jounce direction (anti-clockwise direction in FIG. 3), and the suspension hub 4 will remain stationary with respect to the vehicle. This causes the piston 38 to move relative to the cylinder 40, in a direction towards the passageway 44. Oil is therefore displaced from the first cylinder 40 into the second cylinder 48 through the passageway 44. The displacement of the oil into the second cylinder displaces the second piston 56 to compress the gas in the volume 58.

In the rebound condition the track guide wheel mounted on the shaft 6 moves away from the static condition in the direction of increasing distance of the track guide wheel from the vehicle hull. In this condition, the suspension arm 2 pivots about the central axis X of the suspension hub 4 (which remains stationary) which causes the first piston 38 to move away from the passageway 44, so that oil is drawn from the second cylinder 48 into the first cylinder 40. This allows the gas in the volume 58 to expand.

With reference to FIGS. 2 and 4, the suspension unit 1 also comprises a rotational damper 62 that is provided in the region of the suspension hub 4 and acts between the suspension arm 2 and the suspension hub 4. The rotational damper 62 generates a rotational damping force when the suspension arm 2 pivots about the suspension hub 4 in either the jounce or rebound direction.

The rotational damper 62 comprises a first damping part 64 in the form of a stator and a second damping part 66 in the form of a rotor. The first damping part 64 is fixed to the suspension hub 4 and therefore cannot rotate with respect to it. The second damping part 66 is attached to the suspension arm 2 such that it rotates about the suspension hub axis X when the suspension arm 2 pivots about the suspension hub axis X.

As shown in FIG. 5, the first damping part 64 comprises an annular casing 68 having a flange 70. The annular casing 68 defines a damping chamber 72 which is arranged to contain a damping fluid such as oil or other hydraulic fluid. The first damping part 64 also comprises diametrically opposite first and second inwardly extending damping projections 74, 75 (or vanes) that radially extend from the annular casing 68 into the damping chamber 72. Each of the inwardly extending damping projections 74, 75 includes an axially extending slot 76 at the radially inward end within which a seal element can be located. The first inwardly extending damping projection 74 has a hollow interior 78 which reduces the overall weight of the component. The second inwardly extending damping projection 75 has a bore 80 that extends through the axial length of the damping projection 75. As shown more clearly in FIG. 4, a replenishing valve 82 comprising a valve element 84 and first and second biasing springs 86, 87 is disposed within the bore 80. A first fluid channel 81 extends from one end of the bore 80 to a first side of the second inwardly extending damping projection 75 and a second fluid channel 83 extends from the other end of the bore 80 to a second side of the second inwardly extending damping projection 75. The replenishing valve 82 ensures that the damping chamber 72 is filled with damping fluid.

The first damping part 64 is attached to the suspension hub 4 by bolts that pass through the holes in the flange 70 into threaded holes provided in the suspension hub 4. Therefore, the first damping part 64 is unable to rotate with respect to the suspension hub 4.

With reference to FIG. 6, the second damping part 66 includes a hub 88 having an axially extending shaft 90, an end portion of which is provided with a male spline 91 on an external surface. The second damping part 66 also comprises diametrically opposite first and second outwardly extending damping projections 92, 93 (or vanes) that radially extend from the hub 88. Each of the outwardly extending damping projections 92, 93 includes an axially extending slot 94 at the radially outward end within which a seal element can be located. The first and second outwardly extending damping projections 92, 93 are each provided with a plurality of through-holes 96 that extend through the thickness of the damping projections 92, 93. Flow restrictors, or valves, are located within the through-holes 96.

As shown in FIG. 7, the second damping part 66 is disposed within the damping chamber 72 formed by the annular casing 68 of the first damping part 64 such that the two damping parts are coaxial with one another. The common axis of the first and second damping parts 64, 66 is coincident with the suspension hub axis X. The inwardly extending damping projections 74, 75 are in contact with the hub 88 of the second damping part 66. Similarly, the outwardly extending damping projections 92, 93 are in contact with the annular casing 68 of the first damping part 66. The inwardly and outwardly extending damping projections 74, 75, 92, 93 divide the damping chamber 72 into four variable volume chamber portions which are each filled with damping fluid such as oil.

First and second jounce chamber portions 98, 99 are defined between the first inwardly extending damping projection 74 and the first outwardly extending damping projection 92, and between the second inwardly extending damping projection 75 and the second outwardly extending damping projection 93 respectively. First and second rebound chamber portions 100, 101 are defined between the second inwardly extending damping projection 75 and the first outwardly extending damping projection 92, and between the first inwardly extending damping projection 74 and the second outwardly extending damping projection 93 respectively. The first fluid channel 81 opens into the first rebound volume 100 and the second fluid channel 83 opens into the second jounce volume 99.

As shown in FIG. 8, the hub 88 of the second damping part 66 is provided with jounce and rebound fluid equalizing passageways 102, 104 that extend through the hub 88 and provide fluid communication between the first and second jounce chamber portions 98, 99 and between the first and second rebound chamber potions 100, 101 respectively. These passageways 102, 104 ensure that the fluid pressure within the first and second jounce chamber portions 98, 99 is the same, and the fluid pressure within the first and second rebound chamber portions 100, 101 is the same.

Referring back to FIG. 4, the damping chamber 72 defined between the annular casing 68 of the first damping part 64 and the second damping part 66 is closed on one side by a rear cover plate 106 that is attached at its periphery to the flange 70 of the first damping part 64. The rear cover plate 106 is provided with a central axially extending portion 108 that extends into a central opening 110 provided in the second damping part 66. A roller bearing element 112 may be disposed between the central opening 110 and the axially extending portion 108 such that the second damping part 66 can smoothly rotate with respect to the cover plate 106. Alternatively, the second damping part 66 may be floating with respect to the rear cover plate 106. The other side of the damping chamber 72 is closed with a damping chamber cover plate 114 that has a flange 116 that is attached to the suspension hub 4. The second damping part 66 is able to rotate relative to the damping chamber cover plate 114. Seal elements are provided for sealing between the first and second damping parts 64, 66 and the rear cover plate 106, between the first damping part 64 and the suspension hub 4, and between the second damping part 66 and the damping chamber cover plate 114.

The shaft portion 90 of the second damping part 66 extends through a central opening that is provided in the cover plate 114 and through a central opening 118 that is provided in the suspension hub 4. The suspension unit 1 is provided with a torque transfer cover plate 120 that covers the cylindrical opening 28 of the suspension arm 2. The cover plate 120 is provided with a central opening 122 which has a female spline 124 on a cylindrical inner surface. The end portion of the shaft 90 is located within the central opening 122 of the cover plate 120 and the male and female corresponding splines 91, 124 engage with one another. The thickness of the torque transfer cover plate 120 is increased in the region of the central opening 122. A cap plate 126 is attached to the torque transfer cover plate 120 and closes the central opening 122. The periphery of the torque transfer cover plate 120 is attached to the suspension arm 2 using bolts or the like (not shown). Consequently, when the suspension arm 2 pivots about the central axis X of the suspension hub 2, the second damping part 66 is rotated about the central axis X with respect to the first damping part 64.

The annular wall 29 of the cylindrical opening 28 of the suspension arm 2 defines a fluid expansion chamber 128 which is bounded by the torque transfer cover plate 120 and the damping chamber cover plate 114. In use, damping fluid such as oil is contained within the fluid expansion chamber 128. This fluid can be supplied to the bearing elements 22 disposed between the suspension arm 2 and the suspension hub 4 in order to lubricate the bearing elements 22. Similarly, the fluid can be supplied to any other moving part, such as the bearing element 35 disposed between the crank pin 34 and the suspension hub 4, for the purposes of lubrication.

The fluid expansion chamber 128 is in fluid communication with the damping chamber 72 through a fluid passageway 130 which leads to the bore 80 of the replenishing valve 82. The replenishing valve 82 operates to ensure that the damping chamber 72 is filled with damping fluid. If the temperature of the damping fluid increases, the damping fluid expands and the valve 82 allows damping fluid to flow from the damping chamber 72 to the expansion chamber 128. Similarly, if the temperature of the damping fluid drops, the valve 82 allows damping fluid from the expansion chamber 128 to be supplied to the damping chamber 72. Using the volume within the cylindrical opening 28 of the suspension arm 2 as the fluid expansion chamber 128 means that it is not necessary to provide the rotational damper 62 with a separate fluid expansion chamber 128. This results in a more compact and lightweight arrangement.

When in use and the suspension arm 2 is in the static position, the rotational damper 62 is in the position shown in FIG. 7 in which adjacent inwardly and outwardly extending damping projections 74, 75, 92, 93 are spaced from one another by approximately 90°. This means that the first and second jounce chamber portions 98, 99 and the first and second rebound chamber portions 100, 101 are all of approximately the same volume.

When the suspension arm 2 pivots about the suspension hub 4 in the jounce direction, the second damping part 66 (which is coupled to the suspension arm 2 by the torque transfer cover plate 120) rotates relative to the first damping part 64 (which is coupled to the suspension hub 4). As shown in FIG. 9, the second damping part 66 rotates in the anti-clockwise direction within the damping chamber 72. The volume of the first jounce chamber portion 98 defined between the first inwardly extending damping projection 74 and the first outwardly extending damping projection 92 decreases as the first outwardly extending damping projection 92 moves towards the first inwardly extending damping projection 74. Similarly, the volume of the second jounce chamber portion 99 decreases as the second outwardly extending damping projection 93 moves toward the second inwardly extending damping projection 75. The volumes of the first and second rebound chamber portions 100, 101 increase as the adjacent inwardly and outwardly extending damping projections move away from one another. As the volumes of the jounce chamber portions 98, 99 decrease, the pressure of the damping fluid within these chamber portions 98, 99 increases. The damping fluid is therefore forced through the flow restrictors that are disposed within the holes 96 within the first and second outwardly extending damping projections 92, 93 and into the first and second rebound chamber portions 100, 101. The rotational damping force is therefore generated by the throttling of the damping fluid through the flow restrictors.

As shown in FIG. 10, when the suspension arm 2 pivots about the suspension hub 4 in the rebound direction, the second damping part 66 rotates in the clockwise direction within the damping chamber 72. The volume of the first rebound chamber portion 100 defined between the second inwardly extending damping projection 75 and the first outwardly extending damping projection 92 decreases as the first outwardly extending damping projection 92 moves towards the second inwardly extending damping projection 75. Similarly, the volume of the second rebound chamber portion 101 decreases as the second outwardly extending damping projection 93 moves towards the first inwardly extending damping projection 74. The volumes of the first and second jounce chamber portions 98, 99 increase as the adjacent inwardly and outwardly extending damping projections move away from one another. As the volumes of the rebound chamber portions 100, 101 decrease, the pressure of the damping fluid within these chamber portions 100, 101 increases. The damping fluid is therefore forced through the flow restrictors that are disposed within the holes 96 within the first and second outwardly extending damping projections 92, 93 and into the first and second jounce chamber portions 98, 99. The rotational damping force is therefore generated by the throttling of the damping fluid through the flow restrictors.

The damping force generated by the rotational damper 62 is higher than can be generated by conventional dampers that are used for in-arm suspension units. Incorporating the rotational damper 62 into the suspension hub 4 results in a compact, and relatively light-weight, arrangement. The heat generated by the rotational damper 62 can also be dissipated through conduction into the vehicle chassis to which the suspension unit 1 is attached.

With reference to FIG. 11, the rotational damper 62 may provide integral jounce and rebound stops in order to limit the movement of the suspension arm 2 about the suspension hub 4 in the jounce and rebound directions. In the embodiment shown in FIG. 11, the first and second outwardly extending damping projections 92, 93 are extended in the circumferential direction (as compared to the embodiment shown in FIG. 6). Each of the outwardly extending damping projections 92, 93 has a jounce abutment face 92a, 93a and a rebound abutment face 92b, 93b. The first and second inwardly extending damping projections 74, 75 also have jounce abutment faces 74a, 75a and a rebound abutment faces 74b, 75b that correspond to the respective faces of the first and second outwardly extending damping projections 92, 93.

As shown in FIG. 12, when the suspension arm 2 pivots about the suspension hub 4 in the jounce direction, after a predetermined rotation angle, the jounce abutment face 92a of the first outwardly extending damping projection 92 comes into contact with the jounce abutment face 74a of the first inwardly extending damping projection 74. Similarly, the jounce abutment face 93a of the second outwardly extending damping projection 93 comes into contact with the jounce abutment face 75a of the second inwardly extending damping projection 75. The abutment of the respective jounce abutment faces prevents the suspension arm 2 from pivoting any further in the jounce direction.

As shown in FIG. 13, when the suspension arm 2 pivots about the suspension hub 4 in the rebound direction, after a predetermined rotation angle, the rebound abutment face 92b of the first outwardly extending damping projection 92 comes into contact with the rebound abutment face 75b of the second inwardly extending damping projection 75. Similarly, the rebound abutment face 93b of the second outwardly extending damping projection 93 comes into contact with the rebound abutment face 74b of the first inwardly extending damping projection 74. The abutment of the respective rebound abutment faces prevents the suspension arm 2 from pivoting any further in the rebound direction.

Providing the rotational damper 62 with internal jounce and rebound stops means that it is not necessary to provide external jounce and rebound stops on the vehicle which would normally be present in order to limit the movement of the suspension arm 2 in the jounce and rebound directions. This reduces the overall part count and therefore assembly and manufacturing costs.

Although in this embodiment the jounce and rebound stops are the end faces of the damping projections, the jounce and rebound stop may be provided in other ways. For example, the first and second damping parts 64, 66 of the rotational damper 62 may be provided with corresponding jounce and rebound stops that are external to the damping chamber 72. Furthermore, the jounce and rebound stops may be provided in the form of a volume of damping fluid trapped between corresponding damping projections. This would prevent the physical contact between mechanical stops. The jounce and/or rebound stops could be a spring or hydraulic damped element to reduce the impact load against the stop and to give a progressive deceleration profile.

1. A suspension unit comprising:
a suspension hub having a connecting element which is arranged to be secured to a vehicle chassis;
a suspension arm which is mounted on the suspension hub for pivoting movement about an axis of the suspension hub;
a resilient arrangement accommodated within the suspension arm and including a displaceable element which is connected by a connecting rod to a crank pin supported by the suspension hub at a position spaced from the hub axis;
a rotational damper acting between the suspension hub and the suspension arm and comprising a first damping part and a second damping part that are rotatable with respect to one another and which define a damping chamber therebetween which is arranged to contain a damping fluid; and
a fluid expansion chamber arranged to contain excess damping fluid and which is in fluid communication with the damping chamber through a fluid passageway;
wherein in use pivoting of the suspension arm about the suspension hub causes displacement of the displaceable element and relative rotation between the first and second damping parts, thereby generating a rotational damping force.

2. A suspension unit according to claim 1, wherein a replenishing valve is disposed in the fluid passageway such that damping fluid can be supplied from the fluid expansion chamber to the damping chamber and from the damping chamber to the fluid expansion chamber.

3. A suspension unit according to claim 1, wherein the suspension arm comprises a wall defining a suspension arm opening within which the suspension hub is disposed and wherein the fluid expansion chamber is disposed within the wall.

4. A suspension unit according to claim 3, further comprising at least one bearing element disposed between the wall of the suspension arm and the suspension hub.

5. A suspension unit according to claim 4, wherein damping fluid can be supplied from the fluid expansion chamber to the at least one bearing element so as to lubricate the bearing element.

6. A suspension unit according to claim 4, further comprising at least one bearing element disposed between the crank pin and the suspension hub.

7. A suspension unit according to claim 6, wherein damping fluid can be supplied from the fluid expansion chamber to the at least one bearing element so as to lubricate the bearing element.

8. A vehicle having a suspension unit in accordance with claim 1.

9. A vehicle as claimed in claim 8, wherein the vehicle is a tracked vehicle, the suspension unit supporting a track guide wheel of the vehicle.

10. (canceled)
